(19) United States
(12) Patent Application Publication
(10) Pub. No.: US 2016/0375580 A1
(43) Pub. Date: Dec. 29, 2016

(54) ROBOT SYSTEM AND ROBOT CONTROL METHOD

(71) Applicant: KABUSHIKI KAISHA YASKAWA DENKI, Kitakyushu-shi (JP)

(72) Inventors: Yusuke KINOSHITA, Kitakyushu-shi (JP); Satoshi SUEYOSHI, Kitakyushu-shi (JP); Shingo TSUTSUMI, Kitakyushu-shi (JP); Kazuhiro HANIYA, Kitakyushu-shi (JP)

(73) Assignee: KABUSHIKI KAISHA YASKAWA DENKI, Kitakyushu-shi (JP)

(21) Appl. No.: 15/190,316

(22) Filed: Jun. 23, 2016

(30) Foreign Application Priority Data
Jun. 23, 2015 (JP) 2015-125641
Jan. 18, 2016 (JP) 2016-007386

(51) Int. Cl. B25J 9/16

(52) U.S. Cl. CPC B25J 9/1628

(57) ABSTRACT

A robot system includes a robot arm including arms and joint parts such that each of the joint parts is connecting two arms, and an auxiliary arm including links, joints and sensors such that each of the joints is connecting two links and that the sensors detect rotation angles of the joints. The auxiliary arm has an end attached to the robot arm at a position which includes multiple joint parts of the joint parts from a base end side to a front end side of the robot arm such that the auxiliary arm follows movement of the robot arm.

### CROSS-REFERENCE TO RELATED APPLICATIONS

The present application is based upon and claims the benefit of priority to Japanese Patent Applications No. 2015-125641, filed Jun. 23, 2015, and No. 2016-007386, filed Jan. 18, 2016. The entire contents of these applications are incorporated herein by reference.

### BACKGROUND OF THE INVENTION

Field of the Invention

An embodiment disclosed herein relates to a robot system and a robot control method.

Description of Background Art

A robot may operate by respectively driving multiple joint parts. An end effector for various applications such as welding or gripping may be attached to a front end of the robot, and various operations such as processing and transfer of a work are performed.

To increase positional accuracy of such a robot, in a stage of performing teaching to the robot, an arm for a teaching operation that emulates the robot may be used (for example, see Japanese Patent Laid-Open Publication No. 2013-184280. The entire contents of this publication are incorporated herein by reference.

### SUMMARY OF THE INVENTION

According to one aspect of the present invention, a robot system includes a robot arm including arms and joint parts such that each of the joint parts is connecting two arms, and an auxiliary arm including links, joints and sensors such that each of the joints is connecting two links and that the sensors detect rotation angles of the joints. The auxiliary arm has an end attached to the robot arm at a position which includes multiple joint parts of the joint parts from a base end side to a front end side of the robot arm such that the auxiliary arm follows movement of the robot arm.

According to another aspect of the present invention, a robot system includes a robot arm including arms and joint parts such that each of the joint parts is connecting two arms, and an auxiliary arm including links, joints and sensors such that each of the joints is connecting two links and that the sensors detect rotation angles of the joints. The auxiliary arm has an end attached to the robot arm at a position which includes multiple joint parts of the joint parts from a base end side to a front end side of the robot arm such that the auxiliary arm follows movement of the robot arm, and the auxiliary arm has the end attached to the robot arm such that a base end axis of the auxiliary arm and a base end axis of the robot arm have an offsetting positional relationship.

According to yet another aspect of the present invention, a method for controlling a robot includes obtaining a position of an auxiliary arm having an end attached to a robot arm such that the auxiliary arm follows movement of the robot arm, and correcting operation of the robot arm in accordance with the position of the auxiliary arm. The robot arm includes arms and joint parts such that each of the joint parts is connecting two arms.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates an outline of a robot system;

FIG. 2 is a block diagram illustrating a structure of the robot system;

FIG. 3 illustrates structures of joint parts of an auxiliary arm;

FIG. 4A is a perspective view illustrating an arm part of the auxiliary arm;

FIG. 4B is a perspective view illustrating a first joint part of the auxiliary arm;

FIG. 4C is a perspective view illustrating a second joint part of the auxiliary arm;

FIG. 4D is a perspective view illustrating a third joint part of the auxiliary arm;

FIG. 5 illustrates another example of a position at which a front end side of the auxiliary arm is attached;

FIG. 6 illustrates a relation between a position at which a base end side of the auxiliary arm is attached and an operation range of a robot arm;

FIG. 7 is a flowchart illustrating processing processes that a robot control device executes;

FIG. 8 illustrates another example of a position at which the front end side of the auxiliary arm is attached; and

FIG. 9 illustrates a position example of the auxiliary arm.

### DETAILED DESCRIPTION OF THE EMBODIMENTS

The embodiments will now be described with reference to the accompanying drawings, wherein like reference numerals designate corresponding or identical elements throughout the various drawings.

In the following, with reference to the accompanying drawings, an embodiment of a robot system and a robot control method that are disclosed in the present application is described in detail. The present invention is not limited by the embodiment described below. Further, in the following, a case is mainly described in which an auxiliary arm having six degrees of freedom of rotation is attached to a robot arm that is a six-axis robot. However, the number of the axes of the robot and the number of the degrees of freedom of rotation of the auxiliary arm are not limited.

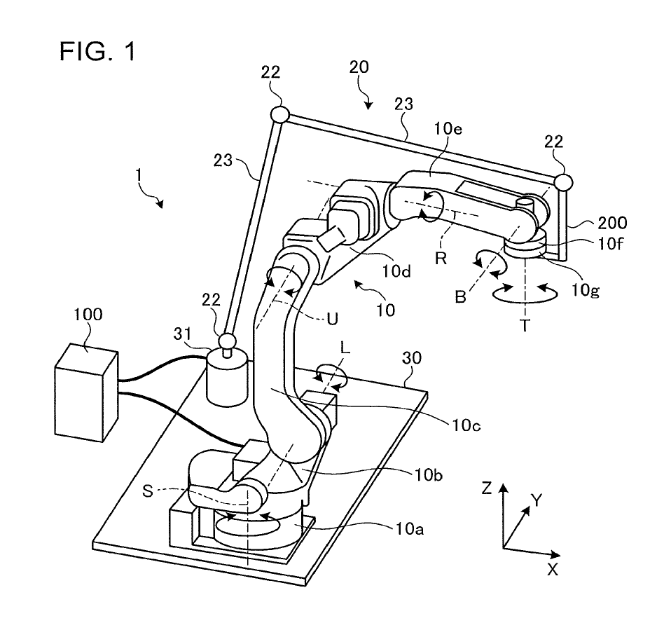

An outline of a robot system according to the embodiment is described using FIG. 1. FIG. 1 illustrates an outline of a robot system 1. In FIG. 1, in order to facilitate understanding of the description, a three-dimensional orthogonal coordinate system that includes a Z axis for which a vertically upward direction is a positive direction is illustrated. Such an orthogonal coordinate system is also illustrated in some other drawings that are used in the following description.

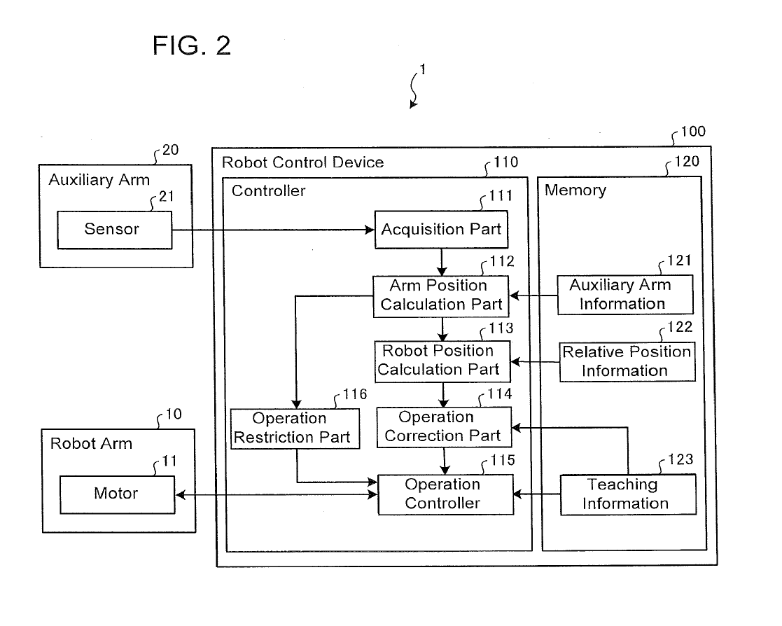

As illustrated in FIG. 1, the robot system 1 according to the embodiment includes a robot arm 10, an auxiliary arm 20, and a robot control device 100. The robot control device 100 is connected to each of the robot arm 10 and the auxiliary arm 20, and performs control of the robot arm 10 and data acquisition from the auxiliary arm 20. Details of the robot control device 100 will be described later using FIG. 2.

First, the auxiliary arm 20 is described. As illustrate in FIG. 1, the auxiliary arm 20 is a link structure in which multiple arm parts 23 are rotatably connected by joint parts 22. Such an auxiliary arm 20 does not have a drive source, and changes its posture following a posture change of the robot arm 10.

Here, the “posture” refers to a combination of rotation amounts in joints. That is, the “posture” does not only refer to an outer shape in appearance. Even when there is no change in the outer shape, when adjacent links rotate relative to each other, the posture is changed. In FIG. 1, the auxiliary arm 20 is illustrated in which the two arm parts 23 are connected using the three joint parts 22. However, the number of the joint parts 22 and the number of the arm parts 23 are not limited.

The joint parts 22 each have one or more degrees of freedom of rotation. The auxiliary arm 20 is formed such that, when the degrees of freedom of rotation of the joint parts 22 are summed, the entire auxiliary arm 20 has six degrees of freedom of rotation at most. Here, that the auxiliary arm 20 has six degrees of freedom of rotation at most is because positions and postures of an object in general have a total of six degrees of freedom including three positions about the X, Y and Z axes illustrated in FIG. 1 and three rotations about the X, Y and Z axes.

That is, when the auxiliary arm 20 that is attached to the robot arm 10 has six degrees of freedom, the posture of the auxiliary arm 20 can be uniquely determined according to various movements of the robot arm 10. Therefore, the auxiliary arm 20 can smoothly follow the movement of the robot arm 10. When the auxiliary arm 20 has seven or more degrees of freedom, there is a possibility that the posture of the auxiliary arm 20 becomes indeterminable so that the movement of the auxiliary arm 20 becomes uncontrollable, and thus it is undesirable for the auxiliary arm 20 to have seven or more degrees of freedom.

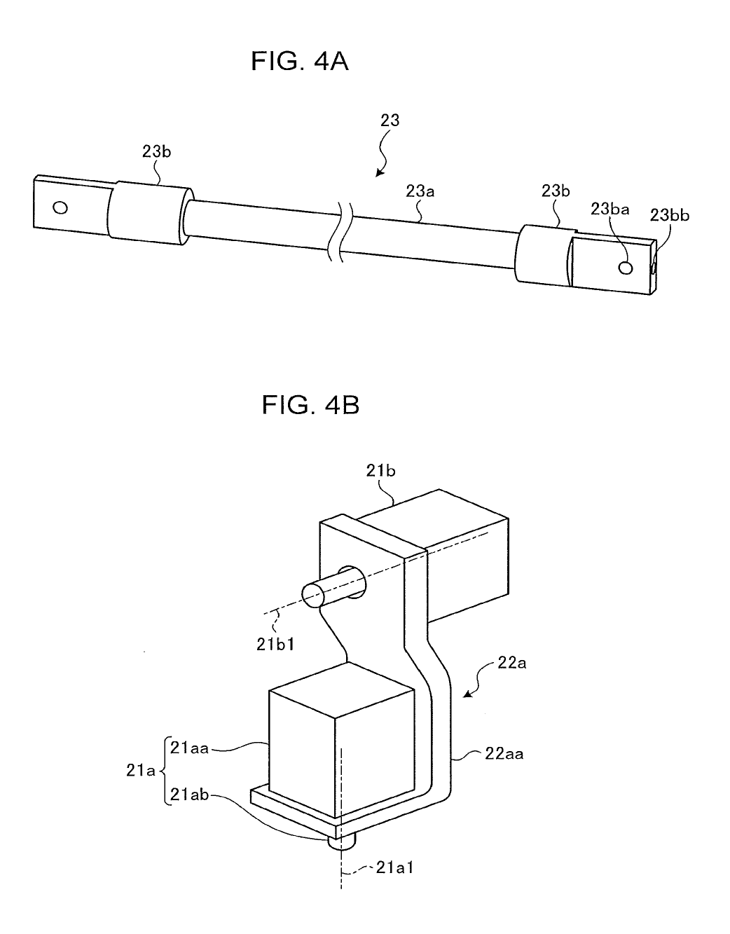

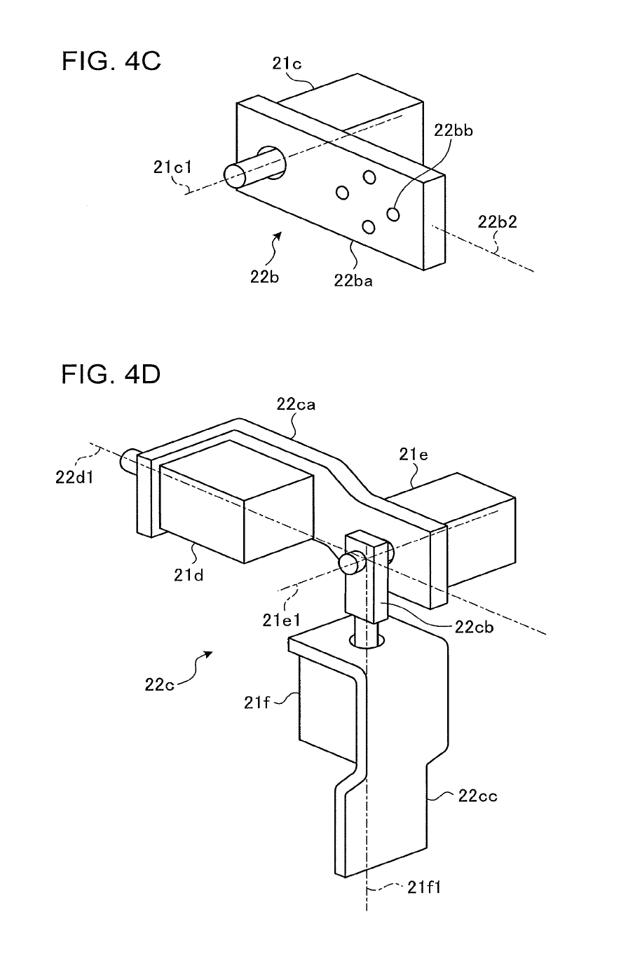

One end (on a front end side) of the auxiliary arm 20 is attached to the robot arm 10 via an attachment member 200. In the case illustrated in FIG. 1, a front end axis (rotation center (21f1) in FIG. 4D to be described later) of the auxiliary arm 20 and a sixth axis (T) that is a front end axis of the robot arm 10 are offset from each other. In this way, by offsetting the two front end axes from each other, attachment of the auxiliary arm 20 to the robot arm 10 becomes easy.

The other end (in a base end side) of the auxiliary arm 20 is attached to an attachment base 31. Here, the attachment base 31, together with the robot arm 10, is fixed on a common base 30, which is a common attachment foundation. The common base 30 is fixed, for example, to a floor of an installation space. It is also possible that the attachment base 31 is omitted and the other end (on the base end side) of the auxiliary arm 20 is directly fixed on the common base 30.

By using such a common base 30, a positional relation between the robot arm 10 and the auxiliary arm 20, that is, relative positions of the two on the base end sides can be accurately determined. In FIG. 1, the case is illustrated where the attachment member 200 is connected to the front end of the auxiliary arm 20. However, it is also possible that the attachment member 200 is integrally formed with the auxiliary arm 20.

Next, the robot arm 10 is described. The robot arm 10 includes, from the base end side toward to the front end side, a base (10a), a turning base (10b), a first arm (10c), a second arm (10d), a third arm (10e), a fourth arm (10f) and a fifth arm (10g).

The base (10a) is fixed on the common base 30. The turning base (10b) supported by the base (10a) so as to be rotatable about a vertically oriented first axis (S). The first arm (10c) is supported by the turning base (10b) so as to be turnable about a horizontally oriented second axis (L). The second arm (10d) is supported by the first arm (10c) so as to be turnable about a third axis (U) that is parallel to the second axis (L).

The third arm (10e) is supported by the second arm (10d) so as to be rotatable about a fourth axis (R) that is perpendicular to the third axis (U). The fourth arm (10f) is supported by the third arm (10e) so as to be turnable about a fifth axis (B) that is parallel to the second axis (L) and the third axis (U).

The fifth arm (10g) is supported by the fourth arm (10f) so as to be rotatable about the sixth axis (T) that is perpendicular to the fifth axis (B). An end effector (not illustrated in the drawings) that is prepared for various applications such as welding or gripping can be detachably attached to the fifth arm (10g) that is a front end arm of the robot arm 10.

Here, the robot arm 10 has joint parts that respectively correspond to the first axis (S), the second axis (L), the third axis (U), the fourth axis (R), the fifth axis (B) and the sixth axis (T), and changes its posture by turning or rotating the arms by motors 11 (see FIG. 2) that are actuators that respectively drive the joint parts.

A joint that has an axis such as the second axis (L), the third axis (U) or the fifth axis (B) that allows an angle formed by adjacent arms to be changed is referred to as a “turning joint;” and a joint that has an axis such as the first axis (S), the fourth axis (R) or the sixth axis (T) that allows adjacent arms to be relatively rotated without changing an angle formed by the adjacent arms is referred to as a “rotating joint.”

However, when the robot arm 10 is caused to perform an operation, it is preferable that an absolute position of the end effector be accurate. Therefore, attempts have been made to improve position accuracy in a stage of performing teaching to a robot. However, even when precise teaching has been performed, the arms of the robot arm 10 may be bent by an external force from a work (not illustrated in the drawings) or may extend or contract due to a change in temperature, and thus the position of the end effector may deviate from a taught position.

Therefore, in the robot system 1 according to the embodiment, a position of the auxiliary arm 20 that follows the movement of the robot arm 10 is acquired, and, based on the acquired position of the auxiliary arm 20, the position of the robot arm 10 is calculated. Further, based on the calculated position of the robot arm 10, the position of the robot arm 10 is corrected.

In this way, when the auxiliary arm 20 that follows the movement of the robot arm 10 is used, even when an external force acts on the robot arm 10, influence of such an external force does not extend to the auxiliary arm 20. This is because the auxiliary arm 20 can freely change its posture following the robot arm 10 that receives the external force.

In this way, since an external force is unlikely to act on the auxiliary arm 20, a strength similar to that of the robot arm 10 is not required for the auxiliary arm 20. Therefore, even when the auxiliary arm 20 is formed thinner and lighter as compared to the arms of the robot arm 10, deformation of the auxiliary arm 20 can be kept sufficiently small. Details of a structure of the auxiliary arm 20 will be described later using FIG. 4A and the like.

Here, in order to suppress deformation of the robot arm 10, the robot arm 10 can be formed using a high rigidity material. However, since the high rigidity material is expensive, cost is increased. On the other hand, when the above-described auxiliary arm 20 is used, there is no need to use an expensive high rigidity material to increase the rigidity of the robot arm 10. Therefore, by using the auxiliary arm 20, the robot arm 10 can operate with high precision while the cost is kept low.

Next, a structure of the robot system 1 according to the embodiment is described using FIG. 2. FIG. 2 is a block diagram illustrating the structure of the robot system 1. In FIG. 2, only components that are used for describing the robot system 1 are illustrated; and description for general components is omitted.

As illustrated in FIG. 2, the robot system 1 includes the robot arm 10, the auxiliary arm 20, and the robot control device 100. Further, the robot arm 10 and the auxiliary arm 20 are each connected to the robot control device 100.

The robot arm 10 is a robot that performs a predetermined operation according to an instruction from the robot control device 100. Further, the robot arm 10 is a robot in which multiple arms are connected by joint part. A motor 11 is provided for each of the joint parts. As described above, the robot arm 10 illustrated in the present embodiment is a six-axis robot. Therefore, the number of the motors 11 is six.

As the motors 11, servo motors that each include an encoder that detects a rotation angle can be used. The robot control device 100 causes the robot arm 10 to assume a desired posture by performing feedback control and the like using encoder values of the motors 11. A specific structure of the robot arm 10 has already been described using FIG. 1, and thus the description is omitted here.

The auxiliary arm 20 is a link structure that is used for detecting a position of the robot arm 10. The auxiliary arm 20 has six joints, and is provided with a total of six sensors 21, one for each of the joints, for detecting rotation angles of the joints. That is, by using six rotation angles that are respectively detected by the six sensors 21 and lengths of the links that are included in the auxiliary arm 20, a three-dimensional position (a combination of coordinates on the X, Y and Z axes of FIG. 1) and a three-dimensional posture (rotation angles about the X, Y and Z axes of FIG. 1) of the front end axis of the auxiliary arm 20 can be derived.

In the present embodiment, a case is described where motors each with an encoder are used as such sensors 21. However, the motors with the encoders are used as motors not for driving but for a purpose of detecting rotation angles of motor shafts using the encoders. As the encoders, it is preferable that encoders having the same precision as or higher precision than that of the encoders of the motors 11 of the robot arm 10 be used. Further, it is also possible that, as the sensors 21, various detectors such as potentiometers capable of detecting rotation angles are used.

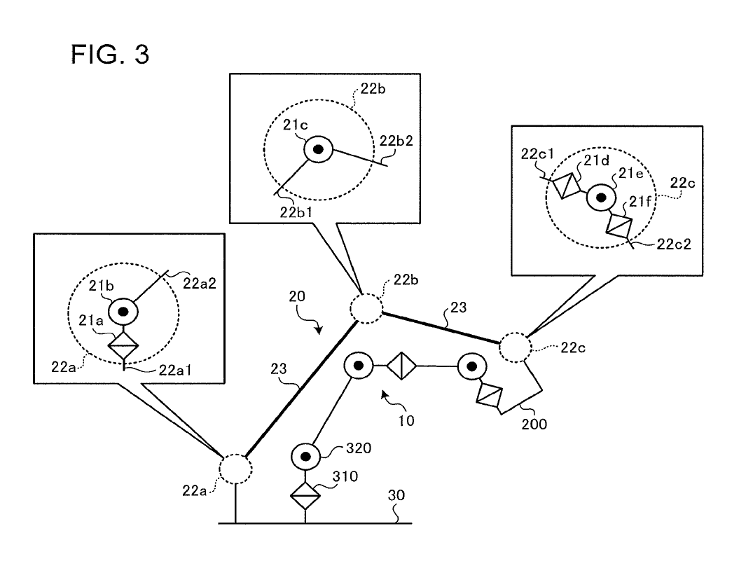

Here, a specific structure of the auxiliary arm 20 is described using FIGS. 3, 4A, 4B, 4C and 4D. FIG. 3 illustrates structures of the joint parts 22 of the auxiliary arm 20.

FIG. 4A is a perspective view illustrating an arm part 23 of the auxiliary arm 20. FIG. 4B is a perspective view illustrating a first joint part (22a) of the auxiliary arm 20. FIG. 4C is a perspective view illustrating a second joint part (22b) of the auxiliary arm 20. FIG. 4D is a perspective view illustrating a third joint part (22c) of the auxiliary arm 20. The shapes of the arm part 23 and the joint parts 22 illustrated in FIG. 4A-4D are examples and can be appropriately changed according to sizes of the sensors 21 and thickness and lengths of the arm parts 23.

Further, the first joint part (22a), which is on the most base end side among the joint parts 22, does not cause the arm parts 23 to deform by a weight of the first joint part (22a), and thus, may have a larger weight than the other joint parts 22. Therefore, an existing mechanism having an axial structure corresponding to the first joint part (22a), such as a part of the robot, may be diverted for use as the first joint part (22a). In this way, cost related to a new design can be suppressed.

As illustrated in FIG. 3, the auxiliary arm 20 has the three joint parts 22 including the first joint part (22a), the second joint part (22b) and the third joint part (22c). In FIG. 3, the joints of the robot arm 10 and the auxiliary arm 20 are illustrated using symbols. Diamond shapes represent the above-described rotating joints 310, and circles represent the above-described turning joints 320.

Here, a diagonal line of a diamond shape symbol corresponding to a rotating joint 310 corresponds to a rotation plane of the joint, and the joint rotates about a rotation axis perpendicular to such a diagonal line. Further, a point marked at a center of a circle corresponding to a turning joint 320 corresponds to a rotation axis, and the joint rotates about such a rotation axis.

In order to avoid complication of the drawing, the symbols of the rotating joints 310 and the turning joints 320 are each kept at one place in the drawing. That is, in the drawing, all the diamond shape symbols are the rotating joints 310, and all the circle symbols are the turning joints 320.

As illustrated in Fig. axis 3, the base end sides of the robot arm 10 and the auxiliary arm 20 are fixed to the common base 30, and the front end sides of the robot arm 10 and the auxiliary arm 20 are joined by the attachment member 200. In FIG. 3, the attachment base 31 illustrated in FIG. 1 is omitted.

The robot arm 10 includes, from the common base 30 side (base end side), the rotating joint 310, the turning joint 320, the turning joint 320, the rotating joint 310, the turning joint 320 and the rotating joint 310, in this order. On the other hand, for the auxiliary arm 20, the position order of the rotating joints 310 and the turning joints 320 is the same as the robot arm 10. However, the joints are not positioned such that one joint corresponds to one joint part 22, but are distributed among the first joint part (22a), the second joint part (22b) and the third joint part (22c), which are the three joint parts 22.

Specifically, two joints are positioned in the first joint part (22a) on the most base end side, one joint is positioned in the second joint part (22b), and three joints are positioned in the third joint part (22c) on the most front end side. These joint parts 22 are connected by the two arm parts 23. Lengths of the arm parts 23 are adjusted such that the auxiliary arm 20 can assume a position and a posture overlooking the robot arm 10 from above, for example, when the robot arm 10 operates while bending forward.

Here, a distance between the rotation axes of the joints contained in the first joint part (22a) is smaller than a distance between the first axis (S) and the second axis (L), which are the rotation axes of the joint parts corresponding to the robot arm 10. Further, inter-axis distances of adjacent rotation axes of the joints contained in the third joint part (22c) are also smaller than inter-axis distances of the fourth axis (R), the fifth axis (B) and the sixth axis (T), which are the rotation axes of the joint parts corresponding to the robot arm 10.

In this way, by making the inter-axis distances of the joints in the joint parts 22 smaller than the actual inter-axis distances in the robot arm 10, the joint parts 22 can be made compact. Further, by making the joint parts 22 compact, a possibility that the auxiliary arm 20 and the robot arm 10 interfere with each other can be reduced.

As illustrated in FIG. 3, in the first joint part (22a), a sensor (21a) that corresponds to the rotating joint 310 on the base end side and a sensor (21b) that corresponds to the turning joint 320 on the front end side are respectively included. An external axis (22a1) and an external axis (22a2) are respectively provided on the base end side and the front end side. The external axis (22a1) is fixed to the attachment base 31 illustrated in FIG. 1, and the external axis (22a2) is fixed to the arm part 23 that connects the first joint part (22a) and the second joint part (22b).

Further, in the second joint part (22b), a sensor (21c) that corresponds to the turning joint 320 is included. An external axis (22b1) and an external axis (22b2) are respectively provided on the base end side and the front end side. The external axis (22b1) is fixed to the arm part 23 that connects the first joint part (22a) and the second joint part (22b), and the external axis (22b2) is fixed to the arm part 23 that connects the second joint part (22b) and the third joint part (22c).

Further, in the third joint part (22c), a sensor (21d) that corresponds to the rotating joint 310, a sensor (21e) that corresponds to the turning joint 320, and a sensor (21f) that corresponds to the rotating joint 310 are included. An external axis (22c1) and an external axis (22c2) are respectively provided on the base end side and the front end side. The external axis (22c1) is fixed to the arm part 23 that connects the second joint part (22b) and the third joint part (22c), and the external axis (22c2) is fixed to the above-described attachment member 200.

By the above-described positioning of the joints with respect to the joint parts 22 and adjustment of the lengths of the arm parts 23, the robot arm 10 and the auxiliary arm 20 are unlikely to interfere with each other. The number of the joint parts 22 can be appropriately changed according a size and a movable range of the robot arm 10.

Next, the arm parts 23 of the auxiliary arm 20 are described. As illustrated in FIG. 4A, each of the arm parts 23 has a link part (23a), and attachment parts (23b) that are respectively provided on two ends of the link part (23a). The link part (23a), for example, is a pipe made of a resin such as CFRP (Carbon Fiber Reinforced Plastic). The link part (23a) may also be formed of a solid member.

In this way, the link part (23a) has a higher rigidity as compared to a material that forms the robot arm 10, and is formed using a resin having less thermal expansion. As such a resin, a material such as CFRP having a light weight is preferred. By using such a material, the auxiliary arm 20 can be obtained that has a high positional accuracy and for which the influence due to bending and thermal expansion is extremely small as compared to the robot arm 10.

The attachment parts (23b), for example, are made of a metal such as an aluminum alloy. Each of the attachment parts (23b) is bonded to the link part (23a) by inserting the link part (23a) to an attachment hole (not illustrated in the drawings) that matches an outer diameter of the link part (23a). Thereby, the attachment parts (23b) are fixed to the link part (23a). Further, a front end side of a peripheral surface of each of the attachment parts (23b) is processed to have a flat surface. An attachment hole (23ba) is provided on such a flat surface, and an attachment hole (23bb) is provided on an end surface.

Further, the joint parts 22 are fixed to the attachment hole (23ba) and the attachment hole (23bb). One or both of the attachment hole (23ba) and the attachment hole (23bb) may be omitted depending on the corresponding joint parts 22.

Next, the first joint part (22a) of the auxiliary arm 20 is described. As illustrated in FIG. 4B, the first joint part (22a) has a frame (22aa) that is formed by bending a flat plate into a crank-like shape so as to have mutually perpendicular attachment surfaces, and has the sensor (21a) (see FIG. 3) and the sensor (21b) (see FIG. 3) that are respectively fixed to the attachment surfaces.

The frame (22aa), for example, is made of a metal such as an aluminum alloy. The sensor (21a) has a main body part (21aa) and a rotation shaft (21ab) that protrudes from the main body part (21aa). The other sensors 21 such as the sensor (21b) are also the same. Therefore, description about a component included in the sensors 21 is omitted in the following.

A hole that allows the rotation shaft (21ab) to penetrate is provided on the above-described attachment surface of the frame (22aa). The rotation shaft (21ab) protrudes from a surface on a side opposite to a side where the main body part (21aa) is positioned. Here, a rotation center (21a1) of the rotation shaft (21ab) and a rotation center (21b1) of a rotation shaft of the sensor (21b) are orthogonal to each other.

The rotation shaft (21ab) is fixed to the attachment base 31 (see FIG. 1), and the rotation shaft of the sensor (21b) is fixed to the attachment hole (23ba) (see FIG. 4A) of the attachment part (23b) of the arm part 23.

Next, the second joint part (22b) of the auxiliary arm 20 is described. As illustrated in FIG. 4C, the second joint part (22b) has a frame (22ba) that is a rectangular flat plate, and the sensor (21c) (see FIG. 3). The frame (22ba), for example, is made of a metal such as an aluminum alloy.

Further, a penetrating attachment hole (22bb) is provided on the frame (22ba). A rotation shaft of the sensor (21c) is fixed to the attachment hole (23ba) (see FIG. 4A) of the attachment part (23b) of the arm part 23 that connects the first joint part (22a) and the second joint part (22b). A rotation center (21c1) of the rotation shaft of the sensor (21c) and the rotation center (21b1) illustrated in FIG. 4B are parallel to each other.

The attachment part (23b) of the arm part 23 that connects the second joint part (22b) and the third joint part (22c) is fixed to the second joint part (22b) by a fastener such as a bolt inserted into the attachment hole (22bb) illustrated in FIG. 4C.

Next, the third joint part (22c) of the auxiliary arm 20 is described. As illustrated in FIG. 4D, the third joint part (22c) is formed by coupling a frame (22cc) and the sensor (21f) via a coupling member (22cb) to a structured formed by a frame (22ca), the sensor (21d) and the sensor (21e), the frame (22cc) being formed by bending a flat plate into a crank-like shape, and the structure formed by the frame (22ca), the sensor (21d) and the sensor (21e) being the same structure as the first joint part (22a). The frame (22ca), the coupling member (22cb) and the frame (22cc), for example, are each made of a metal such as an aluminum alloy. Further, the attachment member 200 (see FIG. 1) is attached to the frame (22cc).

A rotation shaft of the sensor (21d) is fixed to the attachment hole (23bb) (see FIG. 4A) of the attachment part (23b) of the arm part 23 that connects the second joint part (22b) and the third joint part (22c). Further, a rotation shaft of the sensor (21e) and a rotation shaft of the sensor (21f) are fixed by the perpendicular to the above-described coupling member (22cb) so as to be perpendicular to each other.

From these facts, a rotation center (22d1) of the rotation shaft of the sensor (21d), a rotation center (21e1) of the rotation shaft of the sensor (21e), and a rotation center (21f1) of the rotation shaft of the sensor (21f) are orthogonal to each other. Here, the rotation center (21f1) corresponds to the front end axis of the auxiliary arm 20.

Returning to the description of FIG. 2, the robot control device 100 is described next. The robot control device 100 includes a controller 110 and a memory 120. The controller 110 includes an acquisition part 111, an arm position calculation part 112, a robot position calculation part 113, an operation correction part 114, an operation controller 115, and an operation restriction part 116. The memory 120 stores auxiliary arm information 121, relative position information 122, and teaching information 123.

Here, the robot control device 100 includes, for example, a computer and various circuits, the computer having a CPU (Central Processing Unit), a ROM (Read Only Memory), a RAM (Random Access Memory), a HDD (Hard Disk Drive), input and output ports, and the like.

The CPU of the computer, for example, by reading out and executing a program stored in the ROM, functions as the acquisition part 111, the arm position calculation part 112, the robot position calculation part 113, the operation correction part 114, the operation controller 115 and the operation restriction part 116 of the controller 110.

Further, it is also possible that at least one or all of the acquisition part 111, the arm position calculation part 112, the robot position calculation part 113, the operation correction part 114, the operation controller 115 and the operation restriction part 116 are implemented using hardware such as an ASIC (Application Specific Integrated Circuit) or an FPGA (Field Programmable Gate Array).

Further, the memory 120, for example, corresponds to the RAM or the HDD. The RAM or the HDD can store the auxiliary arm information 121, the relative position information 122 and the teaching information 123. It is also possible that the robot control device 100 acquires the above-described program and various pieces of information from another computer that is connected by a wired or wireless network or a portable recording medium.

The controller 110 performs operation control of the robot arm 10, and corrects the operation of the robot arm 10 based on detection results acquired from the sensors 21 of the auxiliary arm 20.

The acquisition part 111 acquires rotation angles of the joints, the rotation angles being detected by the sensors 21 of the auxiliary arm 20. Here, since the auxiliary arm 20 has six sensors 21, one for each of the six joints, a set of six rotation angles that are detected by the six sensors 21 is acquired. Here, a rotation angle refers to a displacement amount from a reference rotation angle. The acquisition part 111 corresponds to an acquisition process and an acquisition means.

It is also possible that a timing when the acquisition part 111 acquires the detection results of the sensors 21 and a timing when the operation controller 115 (to be described later) acquires encoder values from the motors 11 of the robot arm 10 are synchronized.

In this case, the two timings may be the same, or a maximum deviation between the two timings may be kept within the same period, that is, within a predetermined period of time. Such a synchronization process, for example, can be realized by a clock function that is provided in the above-described CPU.

The arm position calculation part 112 calculates a position of the auxiliary arm 20 based on the detection results received from the acquisition part 111 and the auxiliary arm information 121 of the memory 120. Here, the “position” of the auxiliary arm 20 is a “front end position” of the auxiliary arm 20, for example, is a position of a reference point (not illustrated in the drawings) that is set on the frame (22cc) illustrated in FIG. 4D. A “base end position” of the auxiliary arm 20, for example, is a position of a point at which the surface of the frame (22aa) illustrated in FIG. 4B from which the rotation shaft (21ab) protrudes and the rotation center (21a1) of the rotation shaft (21ab) intersect.

The auxiliary arm information 121 contains data of the auxiliary arm 20 such as sizes of the joints, orientations of the rotation axes and lengths of the links that connect the joints. Therefore, from the auxiliary arm information 121 and the rotation angles that are detected by the six sensors 21, the arm position calculation part 112 can calculate the front end position of the auxiliary arm 20, more specifically, the relative position of the front end position with respect to the base end position.

The above-described auxiliary arm information 121 contains information about a singularity of the auxiliary arm 20. However, this point will be described later in conjunction with the operation restriction part 116. Further, when the above-described front end position is calculated, the arm position calculation part 112 also calculates postures of the links included in the auxiliary arm 20.

The robot position calculation part 113 calculates a position of the robot arm 10 based on the position of the auxiliary arm 20 received from the arm position calculation part 112 and the relative position information 122 of the memory 120. Here, the “position” of the robot arm 10, for example, is a position of a reference point (not illustrated in the drawings) that is set on the fifth arm (10g) of the robot arm 10. A “base end position” of the robot arm 10, for example, is a position of a point at which the first axis (S) illustrated in FIG. 1 and an upper surface of the common base 30 intersect.

The relative position information 122 is information that includes the base end position of the robot arm 10 and the relative position of the base end position of the auxiliary arm 20, and includes the front end position of the robot arm 10 and the relative position of the front end position of the auxiliary arm 20. Therefore, the robot position calculation part 113 can obtain the front end position of the robot arm 10 from the front end position of the auxiliary arm 20.

Based on the position of the robot arm 10 received from the robot position calculation part 113 and the teaching information 123 of the memory 120, the operation correction part 114 notifies the operation controller 115 of a correction instruction to bring the position of the robot arm 10 close to a taught position of the teaching information 123. Here, the operation correction part 114 may eliminate the deviation from the taught position nu one correction instruction, or may gradually eliminate the deviation from the taught position by multiple correction instructions. The operation correction part 114 corresponds to a correction process and correction means.

The teaching information 123 is created in a teaching stage in which the robot arm 10 is taught an operation, and is information that contains a “job” that is a program that defines an operation path of the robot arm 10.

Based on the teaching information 123, the operation controller 115 causes the robot arm 10 to assume a desired posture by instructing the motors 11. Further, the operation controller 115 improves the operation accuracy of the robot arm 10 by performing feedback control and the like using the encoder values of the motors 11. Further, based on the correction instruction from the operation correction part 114, the operation controller 115 instructs the robot arm 10 to perform an operation to eliminate the deviation from the teaching information 123.

The operation restriction part 116 restricts the operation of the robot arm 10 such that the auxiliary arm 20 does not assume a posture in which the auxiliary arm 20 becomes a singularity. Here, the posture in which the auxiliary arm 20 becomes a singularity refers to a posture in which two or more of the rotation axes of the sensor (21a), the sensor (21d) and the sensor (21f) in FIG. 3 overlap on the same straight line. In this way, when the auxiliary arm 20 assumes the posture in which the auxiliary arm 20 becomes a singularity, there is a possibility that the posture of the auxiliary arm 20 becomes indeterminable so that the movement of the auxiliary arm 20 becomes uncontrollable.

Therefore, the operation restriction part 116 judges whether or not the posture of the auxiliary arm 20 generated by the arm position calculation part 112 matches a condition contained in the auxiliary arm information 121, for example, a condition that the rotation axes of the sensor (21a), the sensor (21d) and the sensor (21f) are oriented “at inclination angles of a predetermined number of degrees or less relative to each other.”When the posture of the auxiliary arm 20 generated by the arm position calculation part 112 matches the condition, the operation restriction part 116 instructs the operation controller 115 to cause the robot arm 10 to perform an operation to increase the inclination angles of the rotation axes relative to each other.

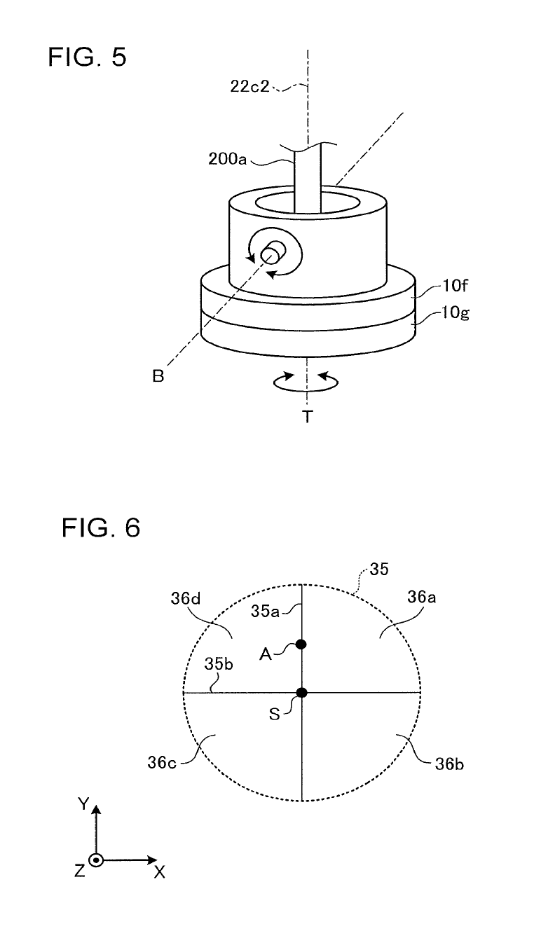

Next, another example of a position at which the front end side of the auxiliary arm 20 is attached is described using FIG. 5. FIG. 5 illustrates the other example of the position at which the front end side of the auxiliary arm 20 is attached. FIG. 5 illustrates a case where the fourth arm (10f) and the fifth arm (10g) of the robot arm 10 illustrated in FIG. 1 both are hollow arms. The fourth arm (10f) turns about the fifth axis (B), and the fifth arm (10g) rotates about the sixth axis (T).

As illustrated in FIG. 5, in the case where the fourth arm (10f) and the fifth arm (10g) both are hollow arms, the rotation center (21f1) (see FIG. 4D), which is the front end axis of the auxiliary arm 20, and the sixth axis (T), which is the front end axis of the robot arm 10, can be coaxially positioned.

In this case, an attachment member (200a) that connects the auxiliary arm 20 and the robot arm 10 is made thin enough to pass through the above-described hollow portion and is inserted into the hollow portion, and is fixed to an inner wall or a front end surface of the fifth arm (10g).

FIG. 5 illustrates the case where the fourth arm (10f) and the fifth arm (10g) both are hollow arms. However, it is also possible that only the fourth arm (10f) is a hollow arm and the fifth arm (10g) is not a hollow arm.

In this case, the attachment member (200a) may be fixed to a surface of the fifth arm (10g) adjacent to the hollow portion of the fourth arm (10f). Even in this case, the rotation center (21f1) (see FIG. 4D), which is the front end axis of the auxiliary arm 20, and the sixth axis (T), which is the front end axis of the robot arm 10, can be coaxially positioned.

Next, a relation between a position at which the base end side of the auxiliary arm 20 is attached and an operation range of the robot arm 10 is described using FIG. 6. FIG. 6 illustrates the relation between the position at which the base end side of the auxiliary arm 20 is attached and the operation range of the robot arm 10. FIG. 6 corresponds to a schematic diagram of the robot arm 10 and the auxiliary arm 20 illustrated in FIG. 1, as viewed from above.

As illustrated in FIG. 6, a reachable range of the robot arm 10 is within a circle 35 centered on the first axis (S) of the robot arm 10. On the other hand, a rotation axis (A) (the rotation center (21a1) in FIG. 4B) on the most base end side of the auxiliary arm 20 is positioned away from the first axis (S).

Here, a line connecting the first axis (S) and the rotation axis (A) is a straight line (35a), and a line passing through the first axis (S) and perpendicular to the straight line (35a) is a straight line (35b). Four regions separated by the straight lines (35a, 35b) are regions (36a, 36b, 36c, 36d).

In this case, it is more preferable for the operation range of the robot arm 10 to be in the region (35a) or the region (35d) than in the region (36b) or the region (36c). This is because a clearance between the auxiliary arm 20 and the robot arm 10 becomes smaller when the robot arm 10 operates in the region (36b) or the region (36c), the regions (36b, 36c) being far away from the rotation axis (A).

Therefore, when the operation range of the robot arm 10 is within a limited range such as 60, 90 or 120 degrees as viewed from above, the rotation axis (A) may be positioned within a semicircular region including the operation range. In this case, it is preferable that the rotation axis (A) be positioned in a portion of the semicircular region other than the operation range.

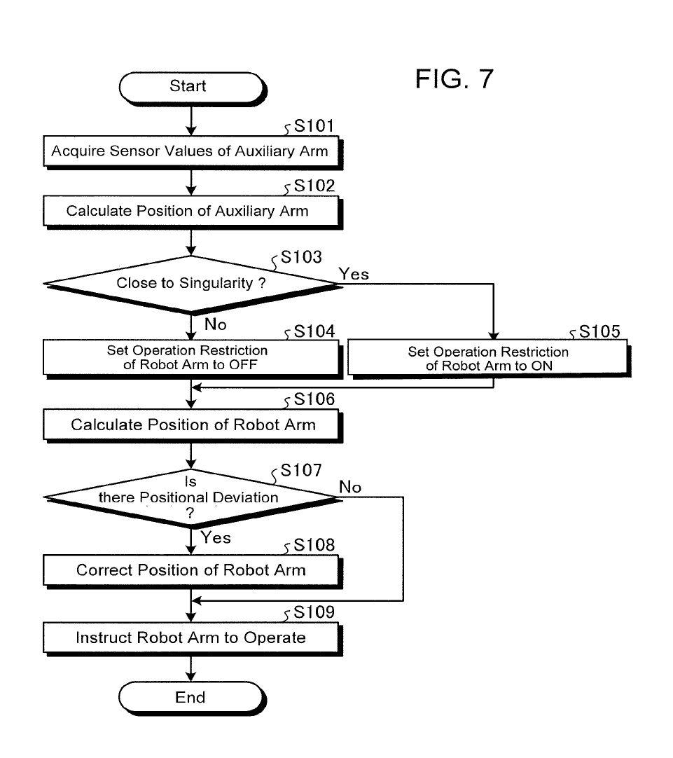

Next, processing processes that the robot control device 100 executes are described using FIG. 7. FIG. 7 is a flowchart illustrating the processing processes that the robot control device 100 executes. As illustrated in FIG. 7, the acquisition part 111 acquires sensor values from the sensors 21 of the auxiliary arm 20 (process (S101)).

Subsequently, based on the sensor values acquired at the process (S101) and the auxiliary arm information 121 of the memory 120, the arm position calculation part 112 calculates a position of the auxiliary arm 20 (process (S102)).

Here, based on the singularity information contained in the auxiliary arm information 121 and a posture of the auxiliary arm 20 generated by the arm position calculation part 112, the operation restriction part 116 judges whether or not the posture of the auxiliary arm 20 is close to a singularity (process (S103)).

When the operation restriction part 116 has judged that the posture of the auxiliary arm 20 is not close to the singularity (No at the process (S103)), the operation restriction part 116 sets operation restriction of the robot arm 10 to OFF (process (S104)), and notifies the operation controller 115 of that the operation restriction of the robot arm 10 has been set to OFF.

On the other hand, when the operation restriction part 116 has judged that the posture of the auxiliary arm 20 is close to the singularity (Yes at the process (S103)), the operation restriction part 116 sets operation restriction of the robot arm 10 to ON (process S105), and notifies the operation controller 115 of that the operation restriction of the robot arm 10 has been set to ON.

Subsequently, based on the position of the auxiliary arm 20 calculated at the process (S102) and the relative position information 122, the robot position calculation part 113 calculates the position of the robot arm 10 (process (S106)).

Next, the operation correction part 114 compares the position of the robot arm 10 calculated at the process (S106) with the teaching information 123, and judges whether or not the position of the robot arm 10 deviates from the previously taught position (process (S107)). When there is a positional deviation (Yes at the process (S107)), the operation correction part 114 instructs the operation controller 115 to correct the position of the robot arm 10 (process (S108)).

On the other hand, when there is no positional deviation (No at the process (S107)), the processing proceeds to a process (S109) without executing the process of the process (S108). Subsequently, the operation controller 115 instructs the robot arm 10 to perform an operation (process (S109)), and terminates the processing.

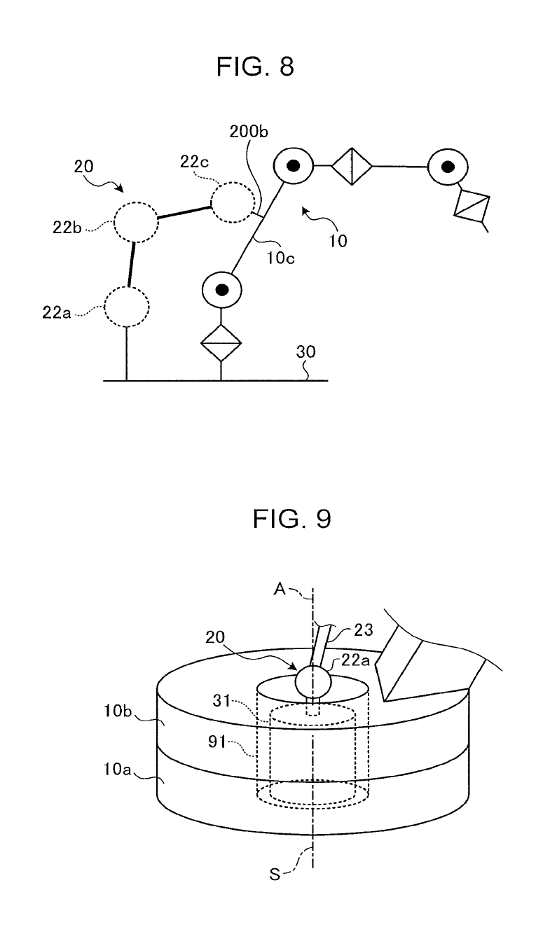

Next, another example of a position at which the front end side of the auxiliary arm 20 is attached is described using FIG. 8. FIG. 8 illustrates the other example of the position at which the front end side of the auxiliary arm 20 is attached. FIG. 8 illustrates a case where the front end side of the auxiliary arm 20 is attached to the first arm (10c) of the robot arm 10 illustrated in FIG. 1 via an attachment member (200b).

As illustrated in FIG. 8, the auxiliary arm 20 according to the present embodiment can be attached to not only the front arm (the fifth arm (10g) in FIG. 1) of the robot arm 10 as described above, but also an arm having two or more joints on the base end side (the common base 30 side) of the robot arm 10.

That is, the auxiliary arm 20 can be attached to any one of the first arm (10c), the second arm (10d), the third arm (10e) and the fourth arm (10f) of the robot arm 10 illustrated in FIG. 1. A position of an arm of an attachment destination can be calculated from the position of the auxiliary arm 20 by the same processes as those described above.

In this way, when the auxiliary arm 20 is attached, depending on the degrees of freedom of the arm of the attachment destination, the number of the sensors 21 can be reduced. For example, in the case illustrated in FIG. 8, the three sensors of the third joint part (22c) can be omitted, and it is possible to use a total of three sensors including the two sensors of the first joint part (22a) and the sensor of the second joint part (22b).

This is because the three-dimensional coordinates of the position at which the auxiliary arm 20 is attached to the first arm (10c) can be determined using the above-described three sensors. The number of the joints of the auxiliary arm 20 is six at most, that is, is six or less, as described above, even when the robot arm 10 is a robot of seven or more axes including a redundant axis (not illustrated in the drawings).

As has been described above, the robot system 1 according to the present embodiment includes the robot arm 10 and the auxiliary arm 20. The robot arm 10 has multiple joint parts. The auxiliary arm 20 has multiple links that are connected by the joints, and has the sensors 21 that detect rotation angles of the joints. Further, one end of the auxiliary arm 20 is attached to the robot arm 10 at a position at which multiple joint parts are included from a base end side to a front end side of the robot arm 10, and thus, the auxiliary arm 20 follows the movement of the robot arm 10.

Therefore, according to the robot system 1 of the present embodiment, the position and the posture of the robot arm 10 can be calculated based on the detection results of the sensors 21 of the auxiliary arm 20 that follows the movement of the robot arm 10. Therefore, positional accuracy during operation of a robot such as the robot arm 10 can be increased.

However, in FIG. 6, the case is illustrated where the rotation axis (A) (the rotation center (21a1) in FIG. 4B) on the most base end side of the auxiliary arm 20 is positioned away from the first axis (S) of the robot arm 10. However, without being limited to this, it is also possible that the rotation axis (A) and the first axis (S) are positioned on the same straight line, that is, in a coaxial positional relationship.

In the following, the case where the rotation axis (A) and the first axis (S) are positioned in a coaxial positional relationship is described using FIG. 9. The rotation axis (A) is referred to as a “base end axis” of the auxiliary arm 20, and the first axis (S) of the robot arm is referred to as a “base end axis” of the robot arm 10.

FIG. 9 illustrates a positioning example of the auxiliary arm 20. Here, FIG. 9 is a schematic perspective view illustrating a case where the base (10a) and the turning base (10b) of the robot arm 10 illustrated in FIG. 1 have hollow structures, and the other end (on the base end side) of the auxiliary arm 20 is positioned in the hollow portion.

As illustrated in FIG. 9, in the base (10a) and the turning base (10b), a space 91 is provided that communicates from an upper surface side of the turning base (10b) toward a lower surface side of the base (10a). Here, as the motor 11 (see FIG. 2) that causes the turning base (10b) to rotate about the first axis (S) with respect to the base (10a), a so-called hollow motor can be used.

In the above-described space 91, the attachment base 31 and the other end (on the base end side) of the auxiliary arm 20 that are illustrated in FIG. 1 are positioned. Here, the attachment base 31 is fixed on the common base 30 illustrated in FIG. 1. In the case of the position illustrated in FIG. 9, it is sufficient for the common base 30 to have an area enough to allow the robot arm 10 to be placed thereon.

Further, it is also possible that the common base 30 is omitted, and the robot arm 10 and the attachment base 31 are positioned on a floor of an installation space. In FIG. 9, the first joint part (22a) and the arm part 23 that connects the first joint part (22a) and the second joint part (22b) that are illustrated in FIG. 3 and the like are illustrated for reference.

As illustrated in FIG. 9, by positioning the rotation axis (A) that is on the most base end side of the auxiliary arm 20 and the first axis (S) of the robot arm 10 in a coaxial positional relationship, the robot arm 10 and the auxiliary arm 20 can be compactly positioned.

FIG. 9 illustrates the case where the rotation axis (A) and the first axis (S) are positioned in a coaxial positional relationship. However, as long as the attachment base 31 and the auxiliary arm 20 do not interfere with the base (10a) and the turning base (10b), it is also possible that the rotation axis (A) and the first axis (S) are offset from each other.

Further, FIG. 9 illustrates the case where the attachment base 31 is positioned in the hollow portion of the base (10a) and the turning base (10b). However, it is also possible that the attachment base 31 is positioned on the upper surface of the turning base (10b), while the rotation axis (A) and the first axis (S) are positioned in a coaxial positional relationship. Even in this case, it is also possible that the rotation axis (A) and the first axis (S) are offset from each other.

Similarly, it is also possible that the attachment base 31 is positioned to the first arm (10c) or the second arm (10d) so that the rotation axis (A) is in a coaxial positional relationship with an axis such as the second axis (L) or the third axis (U). Even in this case, it is also possible that the rotation axis (A) and the axis such as the second axis (L) or the third axis (U) are offset from each other.

Even when teaching that improves positional accuracy is performed in a teaching stage, when a robot actually operates, an actual position may deviate from a taught position. This is because of influences such as that an arm is bent due to application of an external force.

A robot system according to an embodiment of the present invention and a robot control method according to an embodiment of the present invention allow positional accuracy of a robot during operation to be increased.

A robot system according to one aspect of the embodiment includes a robot arm and an auxiliary arm. The robot arm has multiple joint parts. The auxiliary arm has multiple links that are connected by joints, and has sensors that detect rotation angles of the joints. Further, one end of the auxiliary arm is attached to the robot arm at a position at which multiple joint parts are included from a base end side to a front end side of the robot arm, and thus, the auxiliary arm follows movement of the robot arm.

According to one aspect of the embodiment, a robot system and a robot control method, which allow positional accuracy of a robot during operation to be increased, can be provided.

Obviously, numerous modifications and variations of the present invention are possible in light of the above teachings. It is therefore to be understood that within the scope of the appended claims, the invention may be practiced otherwise than as specifically described herein.

What is claimed is:

1. A robot system, comprising:
a robot arm comprising a plurality of arms and a plurality of joint parts such that each of the joint parts is connecting two arms; and
an auxiliary arm comprising a plurality of links, a plurality of joints and a plurality of sensors such that each of the joints is connecting two links and that the plurality of sensors detects rotation angles of the joints,
wherein the auxiliary arm has an end attached to the robot arm at a position which includes a plurality of the joint parts from a base end side to a front end side of the robot arm such that the auxiliary arm follows movement of the robot arm.

2. A robot system according to claim 1, further comprising:
circuitry configured to correct operation of the robot arm based on detection result acquired from the sensors of the auxiliary arm.

3. A robot system according to claim 1, wherein the auxiliary arm has the end attached to the robot arm at a position which includes the plurality of joint parts from the base end side to the front end side of the robot arm such that the auxiliary arm follows movement of the robot arm.

4. A robot system according to claim 3, wherein the auxiliary arm has the end attached to the robot arm such that a front end axis of the auxiliary arm and a front end axis of the robot arm have an offsetting positional relationship.

5. A robot system according to claim 3, wherein the auxiliary arm has the end attached to the robot arm such that a front end axis of the auxiliary arm and a front end axis of the robot arm have a coaxial positional relationship.

6. A robot system according to claim 1, wherein the auxiliary arm has the end attached to the robot arm such that a base end axis of the auxiliary arm and a base end axis of the robot arm have a coaxial positional relationship.

7. A robot system according to claim 2, wherein the auxiliary arm has the end attached to the robot arm such that a base end axis of the auxiliary arm and a base end axis of the robot arm have a coaxial positional relationship.

8. A robot system according to claim 3, wherein the auxiliary arm has the end attached to the robot arm such that a base end axis of the auxiliary arm and a base end axis of the robot arm have a coaxial positional relationship.

9. A robot system according to claim 1, wherein the auxiliary arm comprises the plurality of sensors comprising at least three sensors.

10. A robot system according to claim 1, wherein the auxiliary arm comprises the plurality of joints comprising six joints or less.

11. A robot system according to claim 1, wherein the auxiliary arm comprises a plurality of metal joint components and a plurality of resin arm components such that each of the metal joint components comprises one of the joints and that each of the resin arm components comprises one of the links.

12. A robot system according to claim 1, further comprising:
circuitry configured to restrict operation of the robot arm such that the auxiliary arm does not assume a posture in which the auxiliary arm becomes a singularity.

13. A robot system according to claim 2, wherein the auxiliary arm has the end attached to the robot arm at a position which includes the plurality of joint parts from the base end side to the front end side of the robot arm such that the auxiliary arm follows movement of the robot arm.

14. A robot system according to claim 13, wherein the auxiliary arm has the end attached to the robot arm such that a front end axis of the auxiliary arm and a front end axis of the robot arm have an offsetting positional relationship.

15. A robot system according to claim 13, wherein the auxiliary arm has the end attached to the robot arm such that a front end axis of the auxiliary arm and a front end axis of the robot arm have a coaxial positional relationship.

16. A robot system according to claim 13, wherein the auxiliary arm has the end attached to the robot arm such that a base end axis of the auxiliary arm and a base end axis of the robot arm have a coaxial positional relationship.

17. A robot system according to claim 1, wherein the auxiliary arm comprises the plurality of sensors comprising at least three sensors, and the auxiliary arm comprises the plurality of joints comprising six joints or less.

18. A robot system, comprising:
a robot arm comprising a plurality of arms and a plurality of joint parts such that each of the joint parts is connecting two arms; and
an auxiliary arm comprising a plurality of links, a plurality of joints and a plurality of sensors such that each of the joints is connecting two links and that the plurality of sensors detects rotation angles of the joints,
wherein the auxiliary arm has an end attached to the robot arm at a position which includes a plurality of the joint parts from a base end side to a front end side of the robot arm such that the auxiliary arm follows movement of the robot arm, and the auxiliary arm has the end attached to the robot arm such that a base end axis of the auxiliary arm and a base end axis of the robot arm have an offsetting positional relationship.

19. A method for controlling a robot, comprising:
obtaining a position of an auxiliary arm having an end attached to a robot arm such that the auxiliary arm follows movement of the robot arm; and
correcting operation of the robot arm in accordance with the position of the auxiliary arm,
wherein the robot arm comprises a plurality of arms and a plurality of joint parts such that each of the joint parts is connecting two arms.

20. A method for controlling a robot according to claim 19, wherein the auxiliary arm comprises a plurality of links, a plurality of joints and a plurality of sensors such that each of the joints is connecting two links and that the plurality of sensors detects rotation angles of the joints, and the auxiliary arm has the end attached to the robot arm at a position which includes a plurality of the joint parts from a base end side to a front end side of the robot arm such that the auxiliary arm follows movement of the robot arm.
